(19) United States
(12) Patent Application Publication
(10) Pub. No.: US 2002/0161787 A1
(43) Pub. Date: Oct. 31, 2002

(54) Virtual peak register system

(76) Inventors: D?apos;Arcy Winston Straub, Dillon, CO (US); Stuart Russell Spath, Centennial, CO (US)

Correspondence Address: D'ARCY STRAUB, PO BOX 1237, DILLON, CO, 80435, US

(21) Appl. No.: 10/133,619

(22) Filed: Apr. 26, 2002

Related U.S. Application Data
(60) Provisional application No. 60/286,806, filed on Apr. 26, 2001.

(51) Int. Cl. G06F 12/00

(52) U.S. Cl. 707/200

(57) ABSTRACT

A virtual peak register system is provided that allows individuals who have climbed various mountains to record and display information concerning their ascents over the Internet. The information recorded can be displayed in the form of a general peak register or a personal peak register. The general peak register can display information that includes the names of the individuals who have climbed a particular mountain and the dates of their respective climbs, the information being displayed in reverse chronological order. The personal peak register can display information that includes the names and dates of mountains personally climbed by an individual. The personal peak register can display the information concerning the individual's ascents according to any number of criteria, such as the elevations of the mountains climbed or the dates of the climbs.

### CROSS REFERENCE TO RELATED APPLICATIONS

This application claims priority from and incorporates by reference U.S. Provisional Patent Application No. 60/286,806 filed on Apr. 26, 2001.

### BACKGROUND OF THE INVENTION

For as long as mountains have challenged climbers, those making a successful ascent of a mountain have had a desire to leave a record of their ascent on the summit. In the earliest of times, a climber making a first ascent of a mountain would commonly build a small pile of rocks on the summit which would indicate to any subsequent climber that another person had previously climbed that mountain. However, all subsequent climbers of this mountain would have no idea as to the details of the first ascent—or any subsequent ascents—and these climbers would have no meaningful method to distinguish their ascents from those of other climbers.

The advent of peak registers overcame many of the aforementioned problems. In Colorado, the earliest form of a peak register dates back to 1868 when John Wesley Powell left a piece of paper recording his ascent in a tin can on the summit of the 13,580′ peak which now bears his name, Mt. Powell. In 1915, Roger Toll and The Colorado Mountain Club™ began the practice of placing peak registers, which consisted of small booklets of paper, on summits throughout Colorado. The peak registers allowed hundreds of climbers to make a record of their ascents, a recorded entry in a peak register typically consisting of the climber's name and residence, the date of the climb, and a comment. The peak registers, along with pencils, were stored in canisters to protect the peak registers from the elements. When a peak register became full of entries, the peak register was replaced with a new peak register and the old peak register returned to The Colorado Mountain Club™ and archived.

The practice of placing peak registers on summits has been practiced throughout the United States, including in the Sierra Nevada, the Cascade, and the Appalachian Mountain Ranges. However, despite the widespread practice of using peak registers, their use to record ascents has some considerable disadvantages. Very often, a climber will make a winter ascent of a mountain and cannot record the ascent because the peak register is buried under several feet of snow. Mountains commonly spawn dangerous thunderstorms and the threat of being struck by lightening will often not allow one time to sign a register. Inclement weather involving extreme cold, high winds, rain, or snow can also make the signing of a peak register prohibitive. Furthermore, peak registers signed in the rain or snow can become undesirably weathered by the water.

The climbing of mountains has become a very popular recreational activity and it is not uncommon for some mountains to be climbed by several hundred individuals in one weekend. As a consequence, a peak register on a popular summit can be filled in a very short time and replacing peak registers with a high degree of frequency is burdensome. Furthermore, the increase in individuals who climb mountains has led to a greater sense of stewardship of the mountains. Leave No Trace principles promote concepts and practices which minimize the impacts of man in sensitive environmental areas. Many people believe that the mere presence of a peak register on a summit violates Leave No Trace principles. Today, many peak registers are prematurely removed or “stolen” from summits by those possessing a heightened sense of stewardship, thereby depriving climbers the opportunity to record their ascents.

In addition to recording ascents on peak registers located on the summits of mountains, many individuals record their ascents in their own personal logs. Many guidebooks will provide a list of mountains and a blank spot beside each mountain which allows the individual to record the date a mountain was climbed and perhaps to add a short comment about the climb. Other guidebooks will provide a list of mountains with no blank spots to record information, thereby leaving the individual with the unsatisfactory option of placing a rather limited notation in a very small area. In any case, without the use of computer spreadsheets, an individual's options to record and review a climbing record are limited.

For the foregoing reasons, there is a need for a virtual peak register system which provides individuals with a versatile means for keeping a personal record of their climbs and optionally offers a reliable and environmentally sound means for individuals to record their ascents in a public forum.

### SUMMARY OF THE INVENTION

The interactive computerized method and system according to the present invention employs a communications network, such as the Internet, to allow individuals to record and display information concerning ascents of mountains. The information concerning ascents obtained from individuals over the communications network is stored in a database on a server computer system, such as that of an Internet service provider. The information concerning ascents can be retrieved from the database and subsequently transferred and displayed to individuals according to any number of criteria. In one embodiment of the invention, a General Peak Register can display information that includes the names of the individuals who have climbed a particular mountain and the dates of their respective climbs, the information being displayed in reverse chronological order. In another embodiment of the invention, a Personal Peak Register can display information that includes the names and dates of mountains personally climbed by an individual. The Personal Peak Register can display the information concerning the individual's ascents according to any number of criteria, such as the elevations of the mountains climbed or the dates of the climbs.

### DESCRIPTION OF THE DRAWINGS

FIG. 1 illustrates a network environment such as may be implemented to practice one embodiment of the present invention.

FIG. 2 presents a flow chart for one embodiment of the present invention.

FIG. 3 illustrates one embodiment of a General Peak Register.

FIG. 4 illustrates one embodiment of a Personal Peak Register.

FIG. 5 illustrates one embodiment of a registration page to register an individual.

FIG. 6 illustrates one embodiment of an ascent registration page to record an ascent of a mountain by an individual.

FIG. 7 illustrates one embodiment of a Personal Peak Register identification page.

FIG. 8 illustrates one embodiment of a General Peak Register selection page.

FIG. 9 illustrates one embodiment of a web site consisting of two frames which implements the present invention.

FIG. 10 illustrates one embodiment of a means for selecting a desired action as provided by the present invention.

### DETAILED DESCRIPTION OF THE INVENTION

In describing the various embodiments of the invention, specific terminology will be used for the sake of clarity. However, the invention is not intended to be limited to the specific terms so selected, and it is to be understood that each specific term includes all technical equivalents which operate in a similar manner to accomplish a similar purpose.

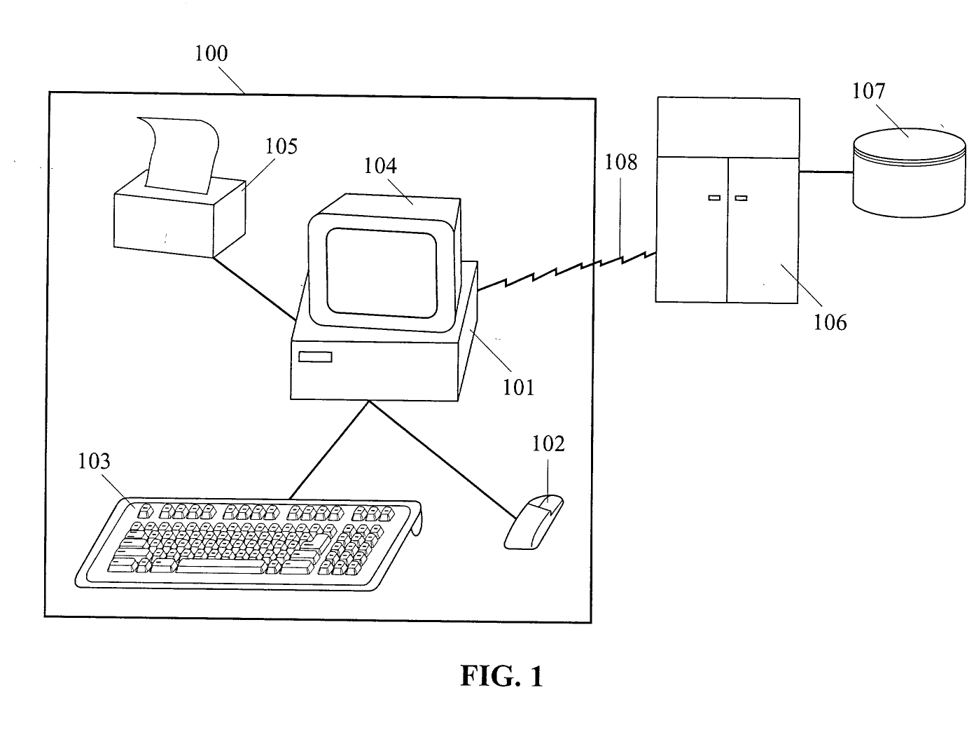

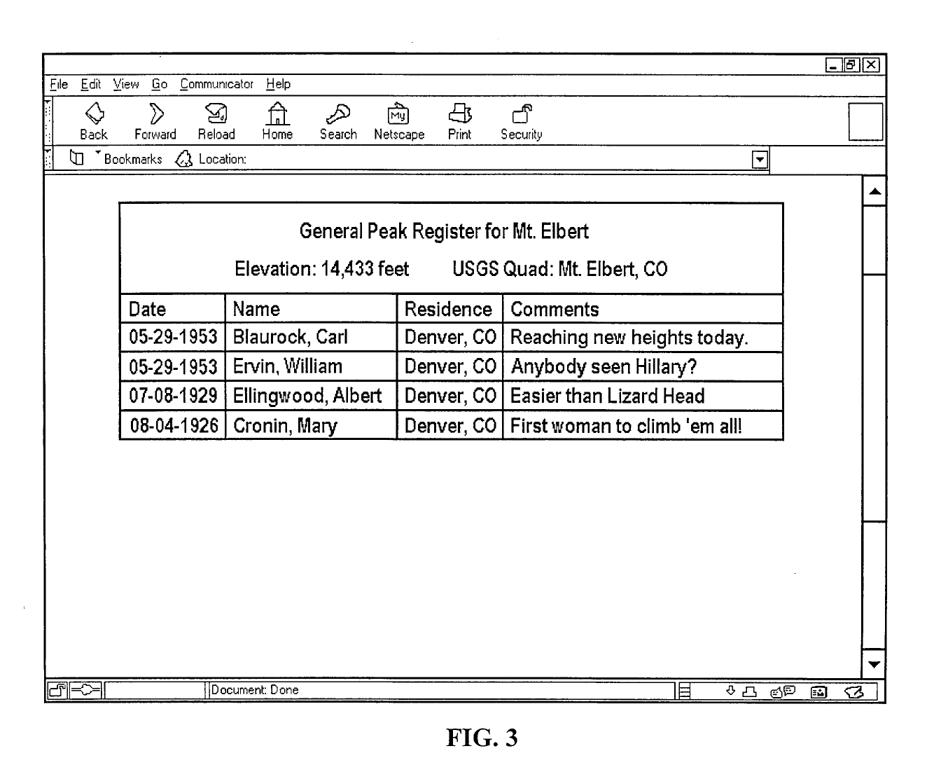

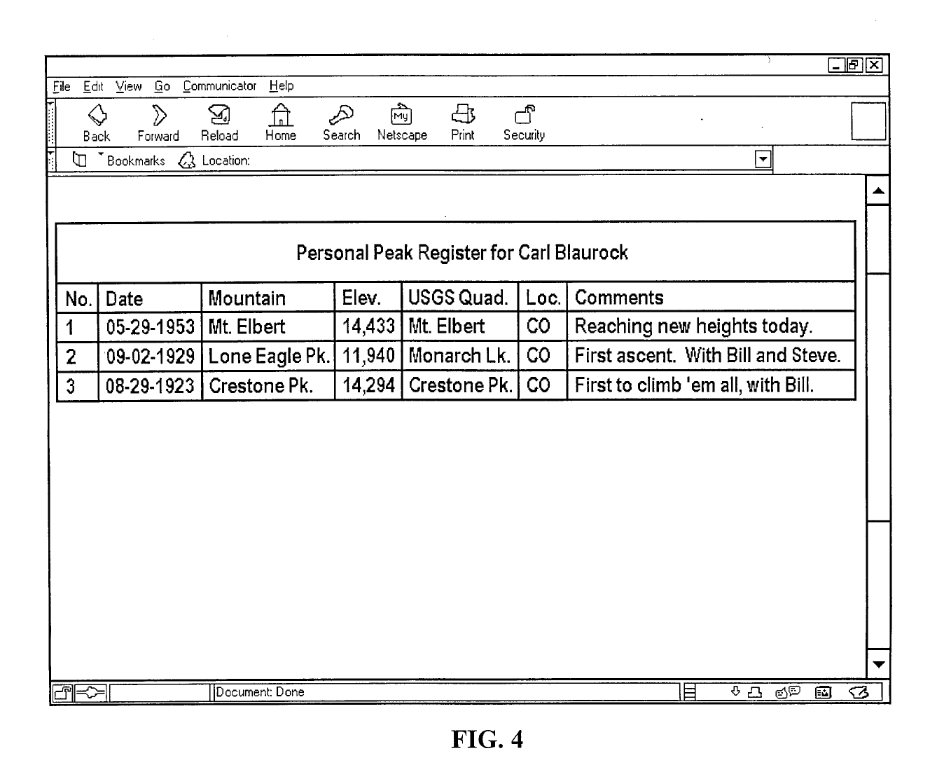

The embodiment illustrated in FIG. 1 is a network environment in which a method according to the present invention may be implemented. The present invention is directed towards an application of a network communications system in which: information concerning ascents of mountains is obtained from an individual using a microcomputer system 100; some or all of the information obtained from the individual is stored in a database 107 of a server computer system 106; some or all of the information in the database 107, according to any number of possible criteria, is subsequently transferred via a communications link 108 from the database 107 to the microcomputer system 100 of the individual; and some or all of the information is displayed on a display device for the individual, for example as shown in FIGS. 3 and 4.

One embodiment of the invention, as illustrated in FIG. 1, is an Internet application in which the microcomputer system 100 accesses the server computer system 106, such as that of an Internet service provider. The microcomputer system may comprise a personal computer system, such as a desktop computer 101, a workstation, or a notebook computer, each of which includes a central processing unit (“CPU”), an input device, and an output device. The CPU may run an operating system, such as Microsoft Windows 2000™ or Windows NT™, and a web browser such as Microsoft Internet Explorer™ or Netscape™. The input device for obtaining information may include, for example, a keyboard 103 and/or a pointing device, such as a mouse 102. The output device for displaying information on a display device may include, for example, a cathode-ray tube display, such as a computer monitor 104, and/or a printer 105.

The server computer system 106 includes a CPU, input devices, and output devices. The server computer system 106 runs an operating system and also includes memory and storage devices for storing the database 107. The server computer system 106 and the microcomputer system 100 run computer executable program code implementing a method according to the present invention. The microcomputer system 100 and the server computer system 106 transfer information via the communications link 108 which may be accomplished by any means known in the art, such as a wired communications link that may, for example, comprise: a modem, including that involving a digital subscriber line; a cable modem; or a T1 line. The invention further contemplates that the communications link 108 may further extend, for example, to: a local area network; a wide area network; or a metropolitan-area network. The communications link 108 may also comprise, according to further embodiments of the invention, a wireless communications link, such as a satellite communications link; or a fixed wireless link, the fixed wireless link capable of transmitting and receiving radio frequencies or lasers.

The embodiment illustrated in FIG. 1 shows the personal computer system with commonly used input and output devices. In further embodiments of the invention, obtaining information may be accomplished, for example, through input devices comprising: a touch-screen; an alphanumeric keypad; a voice recognition system; or a hand-writing recognition system. Displaying information on a display device may be accomplished, for example, through output devices comprising: a liquid crystal display; a television using any type of projection system known in the art; or a screenless display device, such as a retinal scanning device.

The present invention further contemplates the use of a wireless communications link and a portable device for obtaining, transferring and/or displaying information to and from the database 107 of the server computer system 106. For example, a personal digital assistant, such as a Palm™ handheld, and a cellular phone are further embodiments of the present invention which can obtain, transfer and/or display information to and from the database 107 of the server computer system 106.

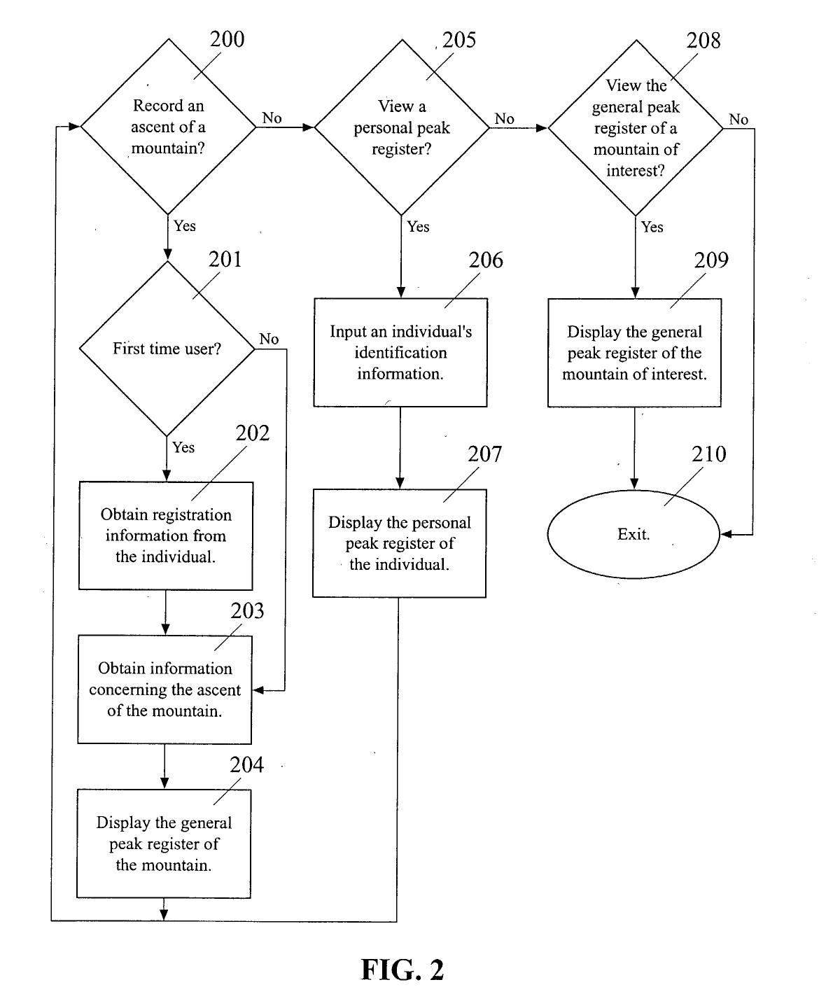

Illustrated in FIG. 2 is a flow chart that presents the general logic associated with a preferred embodiment of the present invention which may be practiced through a web site and the Internet. Decision block 200 represents the options that a user or an individual possesses when first visiting the web site that hosts the present invention. For purposes of the present disclosure, the aforementioned user is a person who does not record an ascent at the web site. In contrast, the aforementioned individual and any additional individual are persons who each record at least one ascent at the web site. Thus, only individuals will proceed to decision block 201, while the user can only proceed to decision block 208. Furthermore, although the invention is described, for the sake of simplicity, in terms of a limited number of persons, the invention should be understood to be used by a multitude of individuals and users that can number in the thousands. In addition, “peak” and other names for similar geographic features, such as “high points”, are understood be synonymous with “mountain” within this disclosure.

Proceeding to decision block 201, the individual wishing to record an ascent at the web site must provide registration information that will distinguish his or her ascents from those of the additional individual. Each ascent recorded by the individual and the additional individual are stored in the database 107. A desired purpose of the present invention is to allow each individual to review each of the mountains that they have climbed and recorded at the web site through their own Personal Peak Register (“PPR”), as shown in FIG. 4. Accordingly, a means must exist to distinguish the climbs recorded by the individual from those of the additional individual. Although each individual's name may provide sufficient information to distinguish their climbs from each other, the possibility exists that the individuals may share the same name. The registration process is the preferred embodiment of the invention to ensure each climb recorded in the database 107 is associated with only one individual.

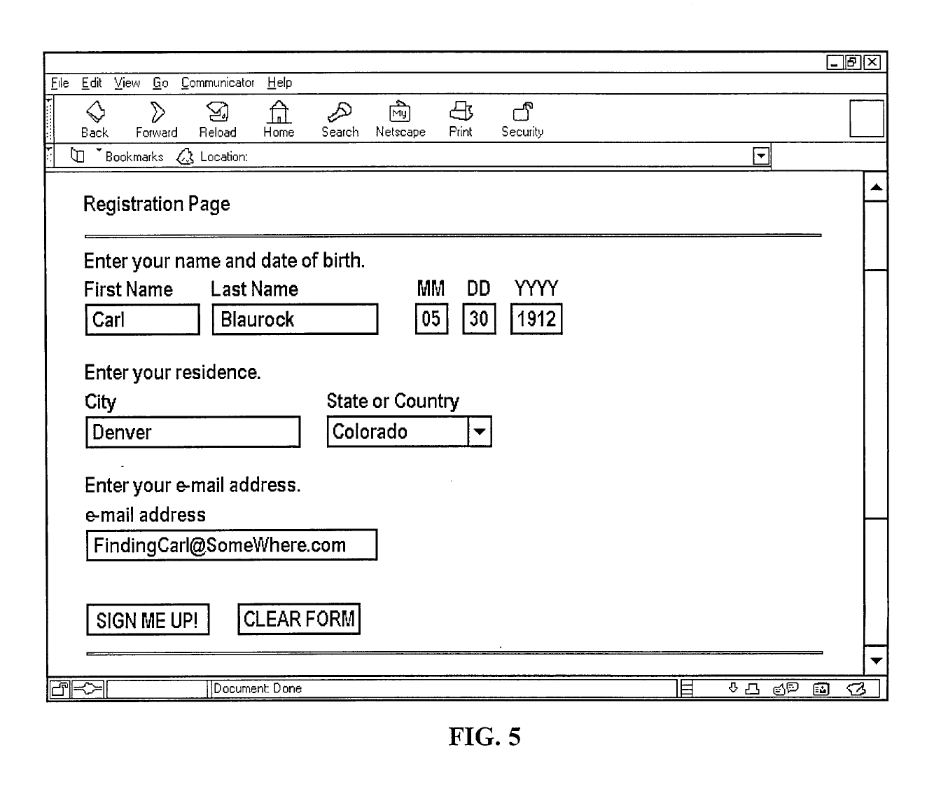

Action block 202, representing the registration process, is undertaken by those individuals who have not previously registered at the web site. Registration information may be obtained through a web site page such as that illustrated in FIG. 5. In the preferred embodiment of the invention, the registration information comprises the individual's first and last name, birth date, town and state (or country) of residence, and e-mail address. The birth date of the individual, in the preferred embodiment of the invention, serves to distinguish the climbs of the two individuals with the same name in the database 107. While an individual may enter his or her birth date, the birth date only serves as an easily remembered eight-digit personal identification number for the individual. Thus, if the individual cannot use his or her birth date to complete the registration process because of the previous registration of another individual with the same name and birth date, then another easily remembered date or sequence of numbers may be selected by the individual to complete the registration process. Less information may be collected from the individual during the registration process, so long as it remains possible to distinguish the climbs recorded by two individuals with the same name. Those skilled in the art will recognize that many means exist to distinguish the climbs of two individuals who share the same name.

More information may be collected during the registration process if a purpose for the additional information exists. In the preferred embodiment of the invention, the individual's town and state of residence is obtained for the purpose of displaying this information on a mountain's General Peak Register (“GPR”), as illustrated in FIG. 3. Obtaining an individual's e-mail address allows individuals to be contacted for any number of purposes, such as commercial advertising.

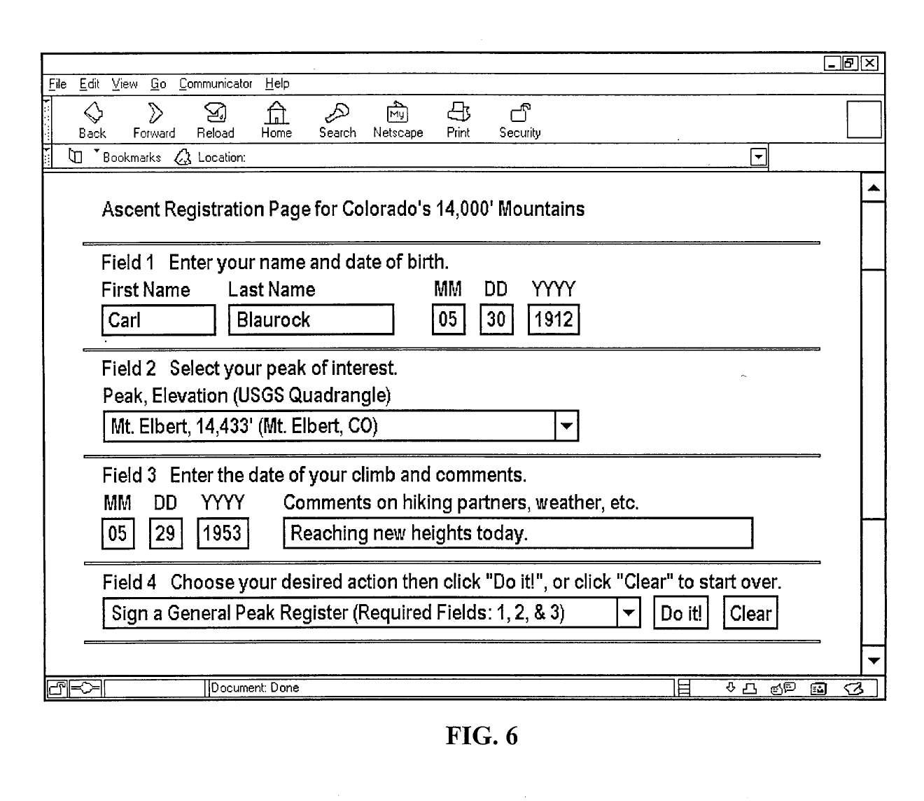

Once the individual has registered, and thus proceeding to action block 203, the individual may record an ascent of a first mountain by the submission of information concerning the ascent. The preferred embodiment of the invention contemplates an ascent registration page, such as that illustrated in FIG. 6, however, other means may be employed to obtain information concerning the ascent. The ascent registration page may comprise several fields to allow for the obtaining of information concerning the ascent made by the individual. For example, the ascent registration page may possess a field for each of the following types of information: a first name of the individual; a last name of the individual; a day, month and year of the individual's birth date or eight-digit personal identification number; a drop down menu from which the individual can identify and select the first mountain for which the individual wishes to record the ascent; a day, month and year of the date of the ascent; and a comment concerning the ascent.

Once the individual has entered information in each of the fields, the step of obtaining the information is completed by the individual clicking on the “Do it!” button, thereby causing the information to be submitted via the communications link 108 to the server computer system 106 which possesses the database 107. The information entered by the individual in each field is subsequently stored in the database 107 as a mountain ascent datum. It will be appreciated, however, that the information stored in the mountain ascent datum can consist of more or less information from that collected during the step of obtaining information concerning the ascent. If the information collected during the step of obtaining information is identical to the information stored in the mountain ascent datum during the step of obtaining the mountain ascent datum, then the two steps are essentially equivalent processes.

In the preferred embodiment of the invention, and referring now to action block 204, the GPR of the first mountain, as illustrated in FIG. 3, is automatically displayed after the mountain ascent datum associated with the individual's ascent of the first mountain is stored in the database 107. This feature allows the individual to review the names of additional individuals who have also climbed the first mountain.

The step of displaying the GPR of the first mountain includes a search for each mountain ascent datum stored in the database 107 that possess the name of the first mountain. Because the first mountain may have an identical name to another mountain, each mountain is further identified in each mountain ascent datum by providing an elevation of the mountain and/or a geographic location of the mountain. For mountains located in the United States, the location of the mountain is preferably designated by the U.S. Geologic 7.5′ topographic quadrangle map upon which the summit of the mountain is mapped. Thus, by including such information in each mountain ascent datum, any ascent of Grizzly Peak 13,988′ located on the Independence Pass, Colorado 7.5′ quadrangle map can be distinguished from any ascent of Grizzly Peak 13,427′ located on the Grays Peak, Colorado 7.5′ quadrangle map. A mountain located outside the United States may be designated by the name of the country in which it is found.

After identifying each mountain ascent datum that possess the name of the first mountain, some or all of the information possessed by each mountain ascent datum identified is selected to be transferred from the database 107 to the individual via the communications link 108 or any other means known in the art. In the preferred embodiment of the invention, such as illustrated in FIG. 3, the only information transferred and subsequently displayed in the GPR for the first individual is: the first and last names of individuals; the dates of the ascents; the towns and states of the residences; and the comments. Once the GPR of the first mountain is displayed using any means known in the art, the first individual will be able to see information associated with additional individuals who have also recorded an ascent of the first mountain. Displaying the first individual's name in a different color than all other names in the GPR will allow the first individual to readily distinguish his or her entry from the names of additional individuals.

It is preferable to present each ascent in reverse chronological order, however, the information may be displayed by other criteria, such as by alphabetical order of the names of the individuals or according to the residences of the individuals. Furthermore, it will be appreciated that the database 107 may contain thousands of mountain ascent datums for the first mountain, or any mountain, and that it may be preferable to transfer and display only a limited number of ascents that have been recorded at one time. For example, the number of ascents displayed in a GPR may be limited by only displaying those ascents within a certain range of dates.

In the preferred embodiment of the invention, the GPR of the first mountain is displayed immediately after the individual has completed recording the information concerning the ascent of the first mountain. However, it will be appreciated that the GPR need not be automatically displayed at this point. In further embodiments of the invention, after the individual records an ascent, the individual's PPR is automatically displayed. In yet another embodiment of the invention, neither the GPR or PPR is automatically displayed. In this embodiment, the GPR or the PPR is only displayed when the individual takes a specific action to display any GPR of a mountain or his or her PPR.

After obtaining and storing the information concerning the ascent of the first mountain by the individual, the individual may record the ascents of additional mountains, as illustrated by the loop in the flow chart in FIG. 2. As indicated by decision block 200, the individual may elect to view his or her PPR at any time after at least one ascent has been recorded. Thus, proceeding to decision block 205, any individual who has previously registered may view his or her PPR, while a user, defined as a person who has not previously registered, may only proceed to view a GPR of a mountain. It will be appreciated that in a further embodiment of the invention, the registration process may be eliminated for any individual that only wishes to record an ascent on a GPR of a mountain, but does not wish to subsequently have the possibility of viewing his or her individual PPR.

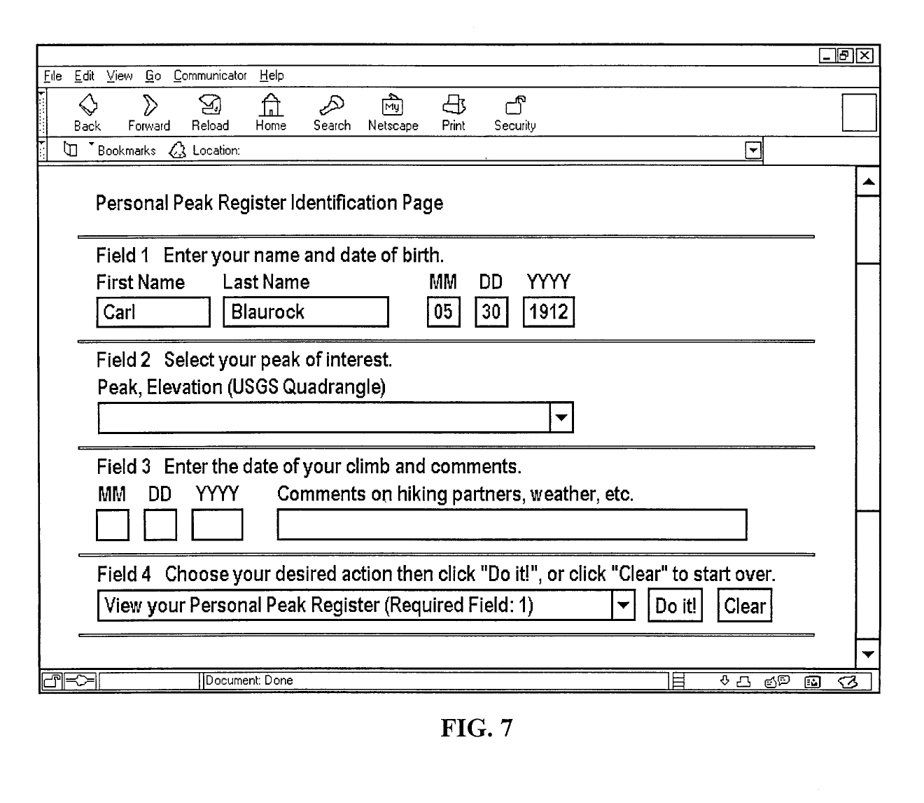

Proceeding to action block 206, the individual may view his or her PPR after inputting identification information such that the individual's corresponding mountain ascent datums previously recorded can be identified in the database 107. In the preferred embodiment of the invention, as illustrated in FIG. 7, the individual provides the identification information in the fields of a PPR identification page. For example, the individual may enter information in the fields for receiving the first and last name of the individual and the birth date of the individual, or other such eight-digit personal identification number that the individual may have selected during the registration process. Those skilled in the art will recognize that many other possibilities exist for identification information which will enable a search routine to identify the individual's corresponding mountain ascent datums. The inputting of identification information is completed by the individual clicking on the “Do it!” button.

After the individual inputs the identification information, a search is conducted in the database 107 to identify each of the mountain ascent datums that correspond to the individual. Subsequent to the search, some or all of the information possessed by each mountain ascent datum identified is selected to be transferred from the database 107 to the individual via the communications link 108 or any other means known in the art. In the preferred embodiment of the invention, such as illustrated in FIG. 4, the only information transferred and subsequently displayed in the PPR for the individual is: the dates of the ascents; the names of the mountains; the elevations of the mountains; the names of the U.S. Geologic 7.5′ topographic quadrangle maps; the states in which each mountain is located; and the comments. For mountains located outside the United States, no information is transferred with regard to topographic quadrangle maps and states of location; rather, information is transferred to indicate the country in which the mountain is located.

Proceeding to action block 207, subsequent to the transfer of the information that relates to the individual's PPR, the information is displayed for the individual using any means known in the art. In the preferred embodiment of the invention, as illustrated in FIG. 4, the ascents of the individual are displayed in reverse chronological order and are numbered. Furthermore, the present embodiment provides the individual with an option to resort the ascents displayed according to any number of criteria, such as displaying the ascents in chronological order, according to the location of the mountains, or according to the elevations of the mountains, either in decreasing or increasing elevation.

It will be appreciated that other embodiments of the PPR exist which serve the purpose of allowing the individual to view the mountains that the individual has climbed and recorded. In further embodiments of the invention, the PPR can contain more or less information than that illustrated in FIG. 4. For example, the minimal amount of information in a PPR can include only a list of the mountains climbed by the individual. Furthermore, the present invention contemplates that the PPR of the individual may be viewed by the additional individuals or the user of the web site. In the preferred embodiment of the invention, only those persons who know the individual's birth date or eight-digit personal identification number may view the individual's PPR. In an alternate embodiment of the invention, the user of the web site may view the PPR of the individual, for example, through a link with the name of the individual.

It will be appreciated that many embodiments of the PPR exist aside from those explicitly described herein. Those skilled in the art will readily recognize obvious variations of the embodiments previously described, but which are directed towards the present invention in which information is obtained concerning a plurality of ascents made by the individual for at least two mountains, some or all of the information is stored in the database 107 of, for example, the server computer system 106, some or all of the information concerning the ascents is transferred from the database 107 to the individual via the communications link 108, and some or all of the information is subsequently displayed to the individual such that the individual can review the ascents of mountains made and recorded.

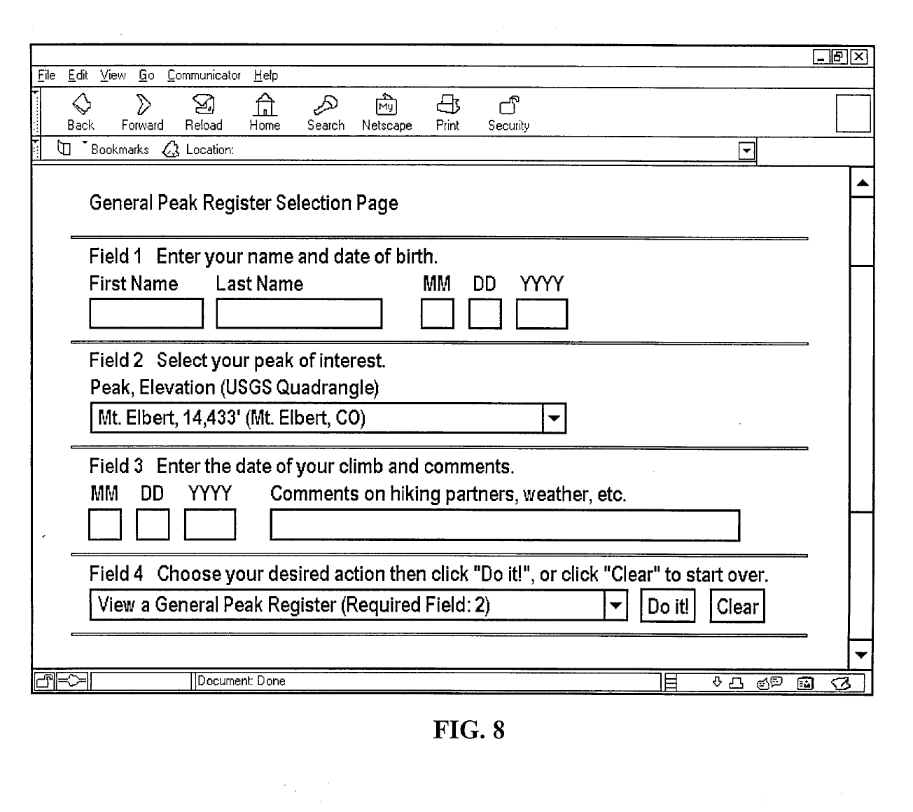

Decision box 208 is reached in the flow chart by the individual who has recorded at least one ascent or the user who wishes not to record an ascent. In any event, the individual or the user may review the GPR of any mountain using a GPR selection page, as illustrated in FIG. 8. The GPR selection page of the web site allows the individual or the user to select a mountain of interest for which it is desirable to receive a display of that mountain's GPR. In a separate embodiment of the invention, it is possible to limit the reception of a display of any GPR to only those individuals who have previously registered.

Action block 209 encompasses a process through which the GPR of interest is displayed. As those skilled in the art will recognize, the process for displaying the GPR in accordance with action block 209 is similar to the process for displaying the GPR in accordance with action block 204. Thus, the previous disclosure associated with action block 204 that is relevant to action block 209 is hereby incorporated by reference.

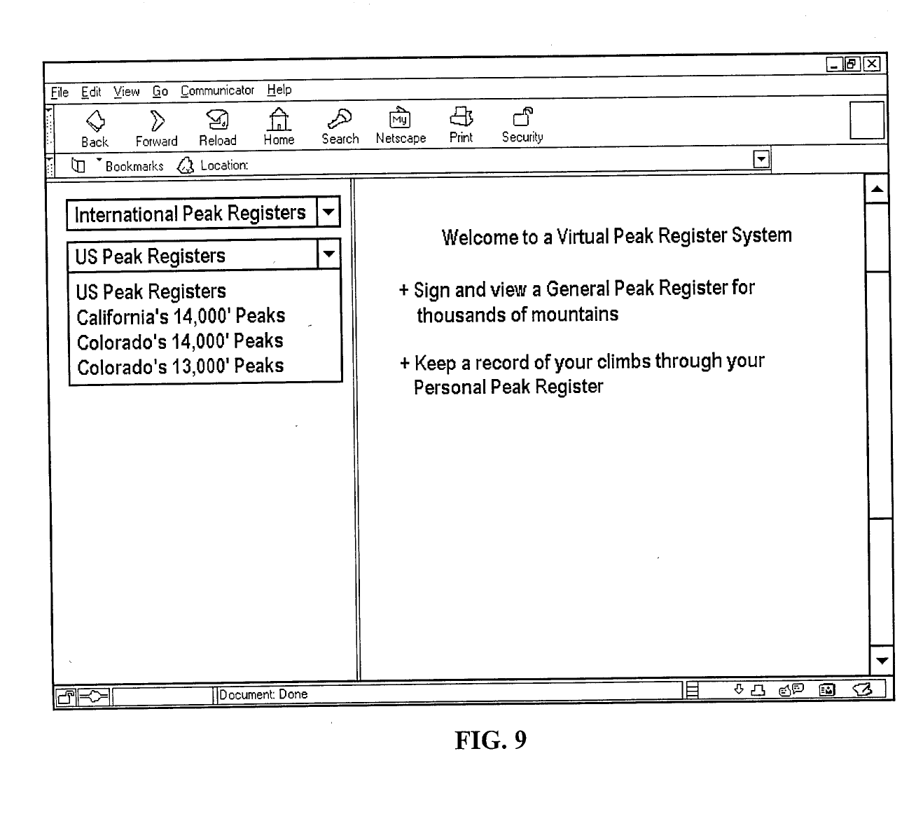

The virtual peak register system of the present invention is directed to the recording of ascents for mountains located throughout the world. As a consequence, the present invention allows for the individual to record an ascent for thousands of mountains. To assist the individual in selecting a mountain for which it is desired to record an ascent, the web site in the preferred embodiment of the invention can include two frames, a right frame and a left frame, as illustrated in FIG. 9. The left frame of the web site possesses at least one drop down menu which presents a selection of mountains grouped according to geographic location, and optionally elevation.

For example, one drop down menu in the left frame may generally offer mountains found in the United States, with the specific selections in the drop down menu including, for example, California's Peaks over 14,000′, Colorado's Peaks over 14,000′, and Colorado's Peaks over 13,000′. Upon the individual selecting one of the specific selections, then a second drop down menu loads in the right frame. The second drop down menu will possess specific mountains from which the individual can select. This preferred embodiment of the invention is applicable when the individual wishes to record an ascent of a mountain or when the individual or the user wishes to view the GPR of a mountain. It will be appreciated by those skilled in the art that other means and strategies exist to expeditiously select one mountain from a large list of mountains numbering in the thousands.

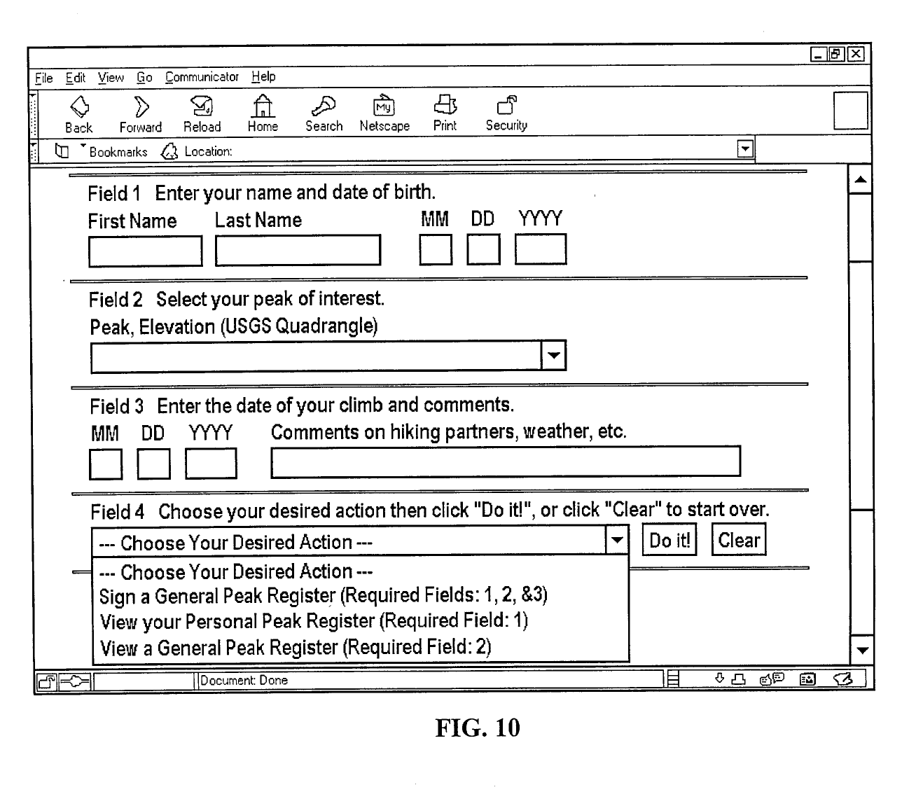

As illustrated in FIGS. 6-8, the ascent registration page, the PPR identification page, and the GPR selection page can use the same web page format, as each page possesses the identical fields which can accept input from the individual. In the preferred embodiment of the invention, the drop down menu, as illustrated in FIG. 10, provides a selection of actions that the individual may desire and each selection instructs which fields must be completed. For example, if the individual wishes to view the GPR of a mountain, the individual selects that desired action from the drop down menu and proceeds to fill in the fields as instructed in the drop down menu. In this embodiment of the invention, some of the desired actions do not require that every field possess information to be inputted. In alternate embodiments of the invention, each desired action may possess its own web page format.

The present invention can also include a means by which the individual may edit a previously recorded ascent of a mountain. Circumstances may arise where the individual realizes that an error has been made in the previously recorded ascent and therefore it is desirable to correct the error. A preferred embodiment of the invention provides an editing page which allows the individual to edit the information possessed by any of the mountain ascent datums that the individual has previously recorded. In a further embodiment of the invention, the editing page can also be adapted to edit the individual's previously submitted registration information.

Further embodiments of the present invention contemplate that the database 107 be searchable according to any desired criterion or set of criteria, and that such search results be displayed for the individual or the user. For example, one embodiment of the invention can allow the individual or the user to search the database 107 for all ascents within a geographic area, such as Colorado, during a specified period of time, such as December 1 through December 31 of a given year. After conducting the search that identifies each mountain ascent datum that satisfies the search criteria, the results are displayed for the individual or the user. In this particular embodiment, the individual or the user can learn about each of the ascents made in Colorado between December 1 and December 31 of the given year that have been recorded.

By way of further example, the individual or the user may wish to search the database 107 according to the criteria of all ascents within a geographic area, such as Colorado, and made by additional individuals with a specific state of residence, such as Washington. In this particular embodiment, the individual or the user can learn about the additional individuals who may be a local source of information concerning geographically distant climbs, or may provide potential climbing partners for future climbs to the geographically distant area.

Another embodiment of the invention contemplates that the database 107 be searchable for specific words. Thus, the individual or the user may wish to search the database 107 according to the criteria of all ascents within a geographic area, such as Colorado, and include a search for “ice axe” in the comment that may be associated with any mountain ascent datum. In this manner, the individual or the user might learn about mountains that provide the challenge of an ascent with an ice axe. It will be appreciated that any number of potential searches are possible with the database 107 and that such searches are only limited by the information associated with the mountain ascent datums.

The present invention can include opportunities to educate the individual or the user about acceptable backcountry practices. Because it is desirable to teach backcountry users about Leave No Trace principles, one embodiment of the present invention can post a Leave No Trace message, such as “Pack it in, pack it out!”, whenever information is displayed to the individual or the user, such as previously described with the displaying of any GPR or PPR.

The present invention also provides an opportunity to obtain donations, such as financial donations, that may be subsequently distributed to support efforts or projects undertaken by organizations or individuals. In one embodiment of the invention, sponsors, such as corporations or foundations, are contracted to provide financial donations that are in relation to some of the mountain ascent datums stored in the database 107. For example, a foundation in Colorado may be contracted to make a $1.00 donation for each mountain ascent datum that is stored in the database 107 and represents an ascent of a mountain over 14,000′ in Colorado during a specific time period, such as during the summer months of a given year. The donations collected from the sponsors are subsequently distributed to beneficiaries, such as organizations that undertake important efforts associated with outdoor recreation, including search and rescue and trail restoration.

The present invention is also directed to computer executable program code, which may be either object or source code, that allows for the keeping of records of mountains summited. In the preferred embodiment of the invention, the computer executable program code may reside on the server computer system 106 and the minicomputer system 100. The computer executable program code may include the programming languages HTML, JavaScript, C Shell, and Perl. JavaScript and HTML may be used to provide an interface to the individual using, for example, the desk top computer 101 equipped with the mouse 102, the keyboard 103, and the computer monitor 104, thereby allowing the individual or the user to record and display information concerning an ascent of a mountain via a web browser, such as Microsoft Internet Explorer™ or Netscape™. Perl routines may be stored on the server computer system 106 and may be used to manage the input, output, storage and deletion of data from the database 107. The C Shell script may be used in conjunction with a database containing mountain listings, the database containing mountain listings including all relevant information associated with each mountain, such as its elevation and its location. The C Shell script may be used to effectively manage the mountains presented in the drop menus of the web pages where the selection of a mountain is desired, such as illustrated in FIGS. 6 and 8. It will be appreciated that other programming languages may be employed to implement the present invention, the programming languages being selected, for example, to accommodate specific requirements of the minicomputer system 100.

Although the invention has been illustrated by reference to specific embodiments, it will be apparent to those skilled in the art that various changes and modifications may be made which fall within the scope of the invention. The invention is intended to be protected broadly within the spirit and scope of the appended claims.

What is claimed is:

1. A method for keeping records of mountains summited, comprising the steps of:
obtaining information concerning a plurality of ascents made by a first individual for at least two mountains, including information concerning an ascent of a first mountain by the first individual and information concerning an ascent of a second mountain by the first individual;
storing in a database some or all of the information concerning the plurality of ascents;
transferring from the database to the first individual via a communications link some or all of the information concerning the plurality of ascents; and
displaying to the first individual some or all of the information concerning the plurality of ascents made by the first individual for at least two mountains, including some or all of the information concerning the ascent of the first mountain by the first individual and some or all of the information concerning the ascent of the second mountain by the first individual.

2. The method of claim 1, wherein the method further comprises the step of obtaining information concerning a separate ascent of the first mountain made by an additional individual.

3. The method of claim 2, wherein the method further comprises the steps of transferring from the database and subsequently displaying for a user some or all of the information concerning the ascent of the first mountain made by the first individual and some or all of the information concerning the separate ascent of the first mountain made by the additional individual.

4. The method of claim 1, wherein the information comprises a name of the first individual, a date of an ascent made by the first individual, and a name of the first mountain ascended by the first individual.

5. The method of claim 4, wherein the information further comprises a comment about an ascent made by the first individual.

6. The method of claim 4, wherein the plurality of ascents made by the first individual for at least two mountains is displayed in chronological order or reverse chronological order with respect to the dates of the ascents made by the first individual.

7. The method of claim 1, wherein the plurality of ascents made by the first individual for at least two mountains is displayed in increasing elevation or decreasing elevation with respect to the plurality of ascents made by the first individual for at least two mountains.

8. The method of claim 1, wherein the step of storing in the database some or all of the information comprises storing the database on a server computer system of a communications network.

9. The method of claim 8, wherein the communications network is the Internet.

10. The method of claim 1, wherein the step of transferring from the database to the user some or all of the information comprises transferring some or all of the information to a microcomputer system.

11. The method of claim 10, wherein the microcomputer system includes any one of a desktop computer, a workstation, a notebook computer, a personal digital assistant and a cellular phone.

12. The method of claim 1, wherein the step of displaying to the user some or all of the information comprises displaying some or all of the information on a display device.

13. The method of claim 12, wherein the display device is a cathode-ray tube display or a liquid crystal display.

14. A method for keeping records of mountains summited, comprising the steps of:
obtaining a plurality of mountain ascent datums, each mountain ascent datum comprising information, including a name of a mountain and a name of an individual;
storing in a database the plurality of mountain ascent datums, wherein the database includes a plurality of mountain ascent datums that possess a name of a first mountain, and the database includes a plurality of mountain ascent datums that possess a name of a first individual;
transferring from the database to the first individual some or all of the information associated with each mountain ascent datum that possess the name of the first mountain;
displaying to the first individual some or all of the information associated with each mountain ascent datum that possess the name of the first mountain such that the individual can review the names of additional individuals who have recorded an ascent of the first mountain;
transferring from the database to the first individual some or all of the information associated with the plurality of mountain ascent datums that possess the name of the first individual; and
displaying to the first individual some or all of the information associated with the plurality of mountain ascent datums that possess the name of the first individual such that the first individual can review the mountains the first individual has climbed and recorded.

15. The method of claim 14, wherein each mountain ascent datum further comprises a comment about an ascent.

16. The method of claim 14, wherein each mountain ascent datum further comprises a date of an ascent.

17. The method of claim 16, wherein the displaying of some or all of the information associated with the plurality of mountain ascent datums that possess the name of the first individual is done according to the date of an ascent such that the first individual can review the mountains the first individual has climbed in reverse chronological order or in chronological order.

18. The method of claim 14, wherein each mountain ascent datum further comprises an elevation of a mountain.

19. The method of claim 18, wherein the displaying of some or all of the information associated with the plurality of mountain ascent datums that possess the name of the first individual is done according to the elevation of a mountain such that the first individual can review the mountains the first individual has climbed by increasing elevation of the mountains or by decreasing elevation of the mountains.

20. The method of claim 14, wherein the method further comprises the steps of:
obtaining a sponsor;
contracting the sponsor to make a donation in relation to some of the mountain ascent datums stored in the database; and
distributing the donation from the sponsor to a beneficiary.

21. Computer executable program code for keeping records of mountains summited, the computer executable program code comprising:
program instructions for receiving information from a plurality of individuals, including a first individual, concerning at least one ascent of a mountain made by each individual;
program instructions for storing the information in a database;
program instructions for performing a search in the database to identify each name of a mountain which the first individual has climbed;
program instructions for displaying all of the mountains climbed by the first individual;
program instructions for performing a search in the database to identify each name of an individual who has climbed a mountain of interest;
program instructions for displaying at least one name of an individual who has climbed the mountain of interest.

22. The computer executable program code of claim 21, wherein the computer executable program code further comprises program instructions for obtaining registration information from each of the plurality of individuals.

23. The computer executable program code of claim 21, wherein the computer executable program code further comprises program instructions for allowing each of the plurality of individuals to edit information stored in the database.

24. The computer executable program code of claim 21, wherein the computer executable program code further comprises program instructions for performing a search in the database to obtain a result, the search conducted according to at least one criterion with each criterion corresponding to an element of the information in the database such that each ascent of a mountain made by each individual that satisfies each criterion can be identified.

25. The computer executable program code of claim 24, wherein the computer executable program code further comprises program instructions for displaying the result of the search.

26. The computer executable program code of claim 24, wherein a first criterion of the search consists of a climb made in a state and a second criterion of the search consists of a range of dates.
